(19) United States
(12) Patent Application Publication
(10) Pub. No.: US 2011/0150664 A1
(43) Pub. Date: Jun. 23, 2011

(54) AEROACOUSTIC ROTOR BLADE FOR A WIND TURBINE, AND WIND TURBINE EQUIPPED THEREWITH

(76) Inventors: Siegfried Mickeler, Schweinfurt (DE); Walter Keller, Dahn (DE)

(21) Appl. No.: 12/976,988

(22) Filed: Dec. 22, 2010

(30) Foreign Application Priority Data
Dec. 22, 2009 (DE) 10 2009 060 650.5

(51) Int. Cl. F03D 1/06

(52) U.S. Cl. 416/241 R

(57) ABSTRACT

A rotor blade and a wind turbine is provided that has such a rotor blade, wherein the absolute length L of the rotor blade extends from the blade attachment to the blade tip and the relative blade length x/L proceeds from the blade attachment. The rotor blade is divided into an inner longitudinal section Lᵢ associated with the blade attachment and an outer longitudinal section L_{ä} associated with the blade tip, wherein the transition from the inner longitudinal section Lᵢ to the outer longitudinal section L_{ä} defines the cross-sectional plane E₀, and the blade tip defines the cross-sectional plane E_{E}. As a function of the relative blade length x/L, the rotor blade has a specific aerodynamic profile with a chord t, a twist ⊖, a relative thickness d/t, a relative curvature f/t, and a relative trailing edge thickness h/t. In order to reduce acoustic emissions without having to accept appreciable losses in performance, it is proposed according to the invention that the cross-sectional plane E₀ is located at a relative blade length x/L in the range between 0.80 and 0.98, the blade chord t of the aerodynamic profile in the cross-sectional plane E_{E} is at least 60% of the blade chord t of the aerodynamic profile in the cross-sectional plane E₀, and the blade twist ⊖ of the aerodynamic profile in the cross-sectional plane E_{E} is greater than the blade twist ⊖ of the aerodynamic profile in the cross-sectional plane E₀.

This nonprovisional application claims priority under 35 U.S.C. §119(a) to German Patent Application No. DE 10 2009 060 650.5, which was filed in Germany on Dec. 22, 2009, and which is herein incorporated by reference.

### BACKGROUND OF THE INVENTION

1. Field of the Invention

The present invention relates to a rotor blade for a wind turbine and a wind turbine.

2. Description of the Background Art

Wind power as an energy source is gaining ever-increasing importance in the use of renewable energy sources for energy production. The reason for this lies in the limited occurrence of primary raw materials, which with an increasing demand for energy leads to shortages and associated cost increases for the energy obtained therefrom. To this is added the fact that conversion of primary raw materials into energy produces a considerable emission of CO₂, which is recognized as the cause of rapidly advancing climate change in recent years. There has thus been a change in attitude on the part of the citizenry in favor of the use of renewable energy.

Wind turbines known for energy production comprise a tower, at the end of which a rotor having radially oriented rotor blades is rotatably mounted. The wind incident on the rotor blades sets the rotor into rotational motion, which drives a generator coupled to the rotor to generate electricity. Efforts are made through appropriate aerodynamic design of the rotor blades to achieve the highest possible efficiency, in other words to convert the kinetic energy inherent in the wind into electrical energy with the least possible loss. One example for such a wind energy system is described in DE 103 00 284 A1.

The use of wind power as an energy source is subject to limitations, however. It is only economical with sufficient wind speed and frequency. Consequently, suitable areas available for constructing wind turbines are limited. Further limitations in site selection result from the adverse environmental effects produced by wind turbines. Due primarily to noise emissions, wind turbines are not allowed to be constructed arbitrarily close to populated areas; instead, the observance of a predefined distance ensures that limit values prescribed by law are not exceeded. In order to make the best possible use of sites that are fundamentally suitable, there is great interest on the part of wind turbine operators in low-noise wind turbines, so as to be able to reduce the distance to populated areas and thereby be able to increase the usable site area.

The primary cause of noise generation in wind turbines resides in the flow around the aerodynamically shaped rotor blades, wherein the inflow velocity determined by the rotor diameter and rotational speed is accorded paramount importance. Modern wind turbines with a diameter of 40 m to 80 m and a tip speed ratio of between 6 and 7 have sound power levels in an order of magnitude between 100 dB(A) and 105 dB(A), which necessitate a distance of 200 m to 300 m from populated areas in order to maintain a limit value there of, e.g., 45 dB(A).

Consequently, there has been no lack of efforts to reduce the noise generation of wind turbines. Thus, the aforementioned DE 103 00 284 A1 proposes to design the trailing edge of a rotor blade to be angled or curved in the plane of the rotor blade in order to reduce acoustic emissions. In this way, the vortices separate from the angled or curved rotor blade trailing edge with a time offset, which results in a reduction in the acoustic emissions.

Known from WO 00/34651, which corresponds to U.S. Pat. No. 6,729,846, is a wind turbine of the generic type with a horizontal rotor axis. Proceeding from the assumption that the rotor blade constitutes the primary sound source, it is proposed there to provide the surface of the rotor blade with a specific roughness for the purpose of sound reduction. The roughness can be achieved by coatings or by adhering films to the blade surface.

DE 10 2005 019 A1 explains that the flow-induced noises arising during operation of wind turbines depend on the velocity of the surrounding flow, and that consequently the blade tip of a rotor blade is accorded particular importance because the circumferential velocity is greatest there. To influence the surrounding flow and thus the noise generation, it is proposed to make the surface of the rotor blade porous, at least in part.

WO 95/19500 also cites the rotor blades around which air flows, in addition to the gearbox, as a cause for noise emissions in wind turbines. Pressure differences between the suction and pressure sides of the rotor blade profile result in turbulence and in some circumstances flow separation at the trailing edge of the rotor blades, which are associated with a corresponding noise generation. In order to reduce the resultant acoustic emissions, it is proposed to fabricate the trailing edge of the rotor blades from a flexible material so that pressure differences between the suction and pressure sides can be compensated for at least partially through elastic deformation of the trailing edge.

For reducing acoustic emissions in wind turbines, EP 0 652 367 A1, which corresponds to U.S. Pat. No. 5,533,865, also provides a modification of the trailing edge of the blade profile. To this end, the trailing edge has an irregular shape, in particular a sawtooth-like design.

### SUMMARY OF THE INVENTION

It is therefore an object of the present invention to provide rotor blades for wind turbines that have reduced acoustic emissions without appreciable losses in performance.

The invention is based on the idea that, in a departure from current practice for noise reduction, the blade chord t in the outer blade tip region of an inventive rotor blade is not reduced or is reduced only slightly, while at the same time the cₐ value of the blade profile in this region is reduced by appropriate provisions. In this regard, the invention proceeds from the premise that a disproportional noise reduction is possible with a reduction in the cₐ value—in contrast to reducing the blade chord t. The very small losses in performance incurred thereby are intentionally accepted. Although a noise increase is indeed associated with larger blade chords t, this does not have an effect to the same degree as the noise reduction resulting from the reduction in the cₐ value in accordance with the invention, so that a positive noise balance remains in terms of the invention. Thus, while the acoustic emissions are significantly reduced by the inventive measures, the energy yield of an inventive wind turbine remains approximately unchanged. The benefit of the invention is to have recognized these complex relationships and to have developed a design for a noise-reduced rotor blade therefrom.

In accordance with the invention, it is proposed that the above-named modifications to the rotor blade extend at most over the outer 20% of the blade length, which is to say that the plane E₀ lies approximately at a relative length x/L of 0.80 or more. This achieves the result that the noise-reducing measures begin at the place of maximum noise generation, and thus a very great noise-reducing effect can be achieved. At the same time, this ensures that the performance of the rotor blade as a whole remains without notable loss, which is to say that the energy yield of a wind turbine equipped with an inventive rotor blade is essentially unimpaired. In this regard, a location of the plane E₀ at a relative length x/L of approximately 0.9 is especially preferred.

While in a conventional rotor blade design the blade tip has a basic outline that is approximately a section of an ellipse, and thus the blade chord t steadily decreases to zero, an inventive rotor blade provides that the blade chord t in the cross-sectional plane E_{E} is at least 60% of the blade chord t in the cross-sectional plane E₀, preferably between 70% and 80%. It is even possible to allow the blade chord t to increase toward the cross-sectional plane E_{E}, for example to a maximum value of 120%. Each of these curves of the blade chord t results in a characteristic curve of the lift coefficient cₐ, whose individual values become smaller as the associated blade chord t increases, so as to keep the induced power loss to a minimum.

A further advantage of larger blade chords t in the outer longitudinal section L_{ä} is that larger profiles can be fabricated more precisely for reasons of manufacturing technology, which contributes to a far better geometrical profile accuracy. On the one hand, a better profile accuracy is reflected in improved power yield, so that the aforementioned minimal performance losses are more than made up for. On the other hand, laminar flow separations or vortex shedding, which are the cause of unexpected high acoustic emissions, are largely avoided.

The reduction of the lift coefficient cₐ can be achieved by various means which result in the inventive effect of noise reduction, whether alone or in combination. Provision is made in accordance with the invention to influence the lift coefficient cₐ by a specific blade twist ⊖ in the outer longitudinal section as a function of the relative length x/L. To this end, the blade twist ⊖ increases continuously in the outer longitudinal section L_{ä} in the region before the cross-sectional plane E_{E}, in the process exceeding the value of the blade twist ⊖ in the cross-sectional plane E₀. The increase in the blade twist ⊖ in the end section can be preceded by a minimum in the region between the planes E₀ and E_{E}.

The noise-reducing effects of the above-described blade twist ⊖ can be reinforced through reduction of the relative thickness d/t and/or the reduction of the relative curvature f/t toward the blade tip, thus achieving an additional noise reduction. Since the relative thickness d/t has a direct effect on the sound power of a rotor, provision is advantageously made in a refinement of the invention to continuously narrow the outer longitudinal section L_{ä} of the rotor blade to approximately 10% relative thickness in the cross-sectional plane E_{E}. Through continuous reduction of the relative curvature f/t in the longitudinal section L_{ä} to the value zero at the cross-sectional plane E_{E}, the sum of the two boundary layer thicknesses of the profile suction and profile pressure sides is minimized, with the advantageous effect that the width of the profile wake decreases, and thus the boundary-layer-induced acoustic emissions as well.

Another measure for noise reduction, which relates not only to the region of the outer longitudinal section L_{ä}, but can also extend to the outer half of the inner longitudinal section Lᵢ, includes designing the height of the trailing edge of the aerodynamic profile that is naturally present to be no greater than 2 ‰ of the chord t in the applicable profile cross-section. As already described above, the background is that, above a certain height, a finite trailing edge considerably broadens the profile wake, and thus increases the acoustic emissions. In this context, a larger blade chord t in the outer longitudinal section L_{ä} in accordance with the invention has proven to be especially advantageous, since in order to meet the aforementioned criterion, small chords t would very quickly lead to profile cross-sections with trailing edge heights so small that they would no longer be manufacturable with an economically justifiable level of cost. With a comparatively large blade chord t, the implementation of a trailing edge height smaller than 2 ‰ of the chord t is considerably simplified.

In order to avoid additional noise sources in the form of flow separations, laminar separation bubbles, vortex shedding, and the like at the outer end of the rotor blade in the cross-sectional plane E_{E}, an additional embodiment of the invention proposes adding a wing tip edge to the cross-sectional plane E_{E}. This wing tip edge, which presupposes—in its rotationally symmetrical design—a curvature starting from zero in the cross-sectional plane E_{E}, is produced by rotating the blade profile through 180° about the chord line. Consequently, the wing tip edge is the longitudinal half of a body of rotation having the contour of the blade profile. Even in the case of relatively large manufacturing tolerances or sharply changing inflow velocities, flow around such a wing tip edge takes place without flow separations, thereby preventing additional acoustic emissions.

Further noise reduction can be achieved according to the invention in that additional pre-bending toward upwind (additional pre-curve) is provided in the outer longitudinal section L_{ä}, either as an alternative or in addition to the customary pre-bending toward upwind (pre-curve). Under wind load, this results in a nonlinear shape of the blade trailing edge in the aforementioned region, which in terms of acoustics leads to a distortion of the acoustic emission characteristics and thus moderates the effects at the noise immission location.

A similar effect is achieved through the provision of sweep, in particular forward sweep, at the outer blade end, since a nonlinear shape of the blade trailing edge modifies the emission characteristics in this case as well. In the case of forward sweep, moreover, the fact that the local inflow is split into a component that is perpendicular to the leading edge of the blade and a component that is parallel to it, also proves to be advantageous. The inward-facing component parallel to the leading edge in the case of forward sweep is responsible for a reduction in the boundary layer thicknesses at the outer end of the blade and thus contributes in an advantageous manner to reducing the noise emissions.

The invention is described in detail below with reference to an exemplary embodiment shown in the drawings, without thereby restricting the invention to this example. The measures described above for noise reduction may also be used in different combinations than those expressly described here without departing from the scope of the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a view of the upwind side of an inventive wind turbine,

FIG. 2 shows a top view of the suction side of an inventive rotor blade of the wind turbine shown in FIG. 1,

FIG. 3 shows a cross-section through the rotor blade from FIG. 2 in the plane E₀,

FIG. 4 shows a cross-section through the rotor blade from FIG. 2 in the plane E_{E},

FIG. 5 shows a representation of the geometric and kinematic relationships at a blade cross-section,

FIG. 6a through 6e show curves of the blade chord t, twist ⊖, relative blade curvature f/t, relative blade thickness d/t, and lift coefficient cₐ, over the longitudinal section L_{ä} of the rotor blade shown in FIG. 2,

FIG. 7 shows a plurality of individual blade cross-sections in the outer longitudinal section L_{ä} of the rotor blade shown in FIG. 2 with radial direction of view with respect to the axis of rotation,

FIG. 8 shows a view of the end region of an inventive rotor blade with additional pre-curve,

FIG. 9 shows a top view of the end region of an inventive rotor blade with forward sweep, and

FIGS. 10a and 10b shows a top view and a longitudinal section of the end region of an inventive rotor blade with wing tip edge.

### DETAILED DESCRIPTION

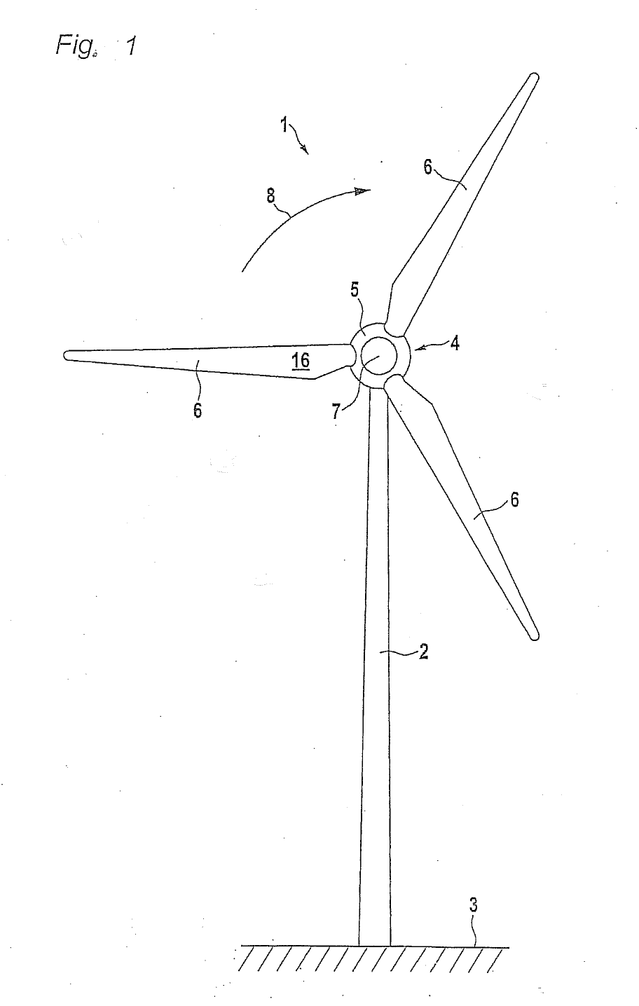

FIG. 1 shows a wind turbine 1 according to the invention which is composed of a tower 2 whose base region is firmly anchored in the ground 3, and a rotor 4 located in the top region of the tower 2 that rotates in the direction of the arrow 8 about an axis of rotation 7 extending perpendicular to the plane of the drawing. The rotor 4 has a hub 5, which is rotatably mounted at the top of the tower 2 and is coupled to a generator for generating electricity. The rotor blades 6 are attached to the rotor 4 in the region of the hub 5.

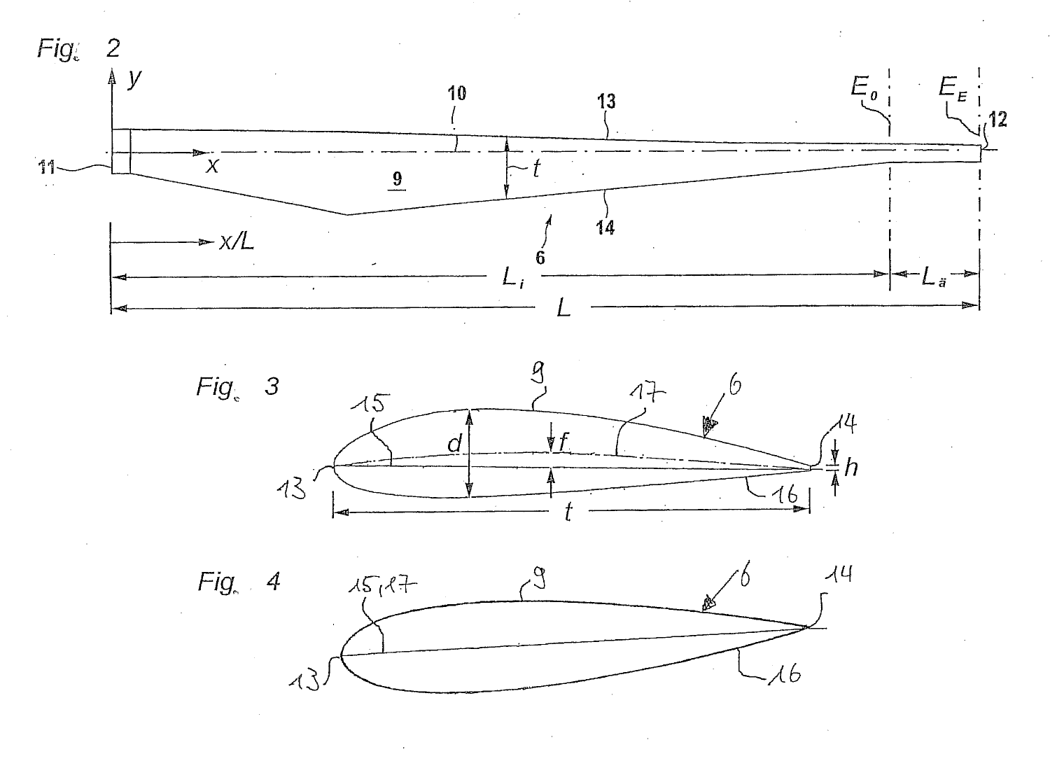

In FIG. 2, a rotor blade 6 of the rotor 4 is shown in a top view of the suction side 9 in an enlarged scale. The longitudinal extent of the rotor blade 6 along its longitudinal axis 10 is labeled as the length L and is defined by the distance from the blade attachment 11 to the blade tip 12. The relative length x/L designates any desired point between the blade attachment 11 and the blade tip 12 starting from the blade attachment 11.

FIG. 2 also shows a longitudinal breakdown of the rotor blade 6 with an inner longitudinal section Lᵢ starting from the blade attachment 11 and an adjoining outer longitudinal section L_{ä} in the direction of the blade tip 12. The transition from the inner longitudinal section Lᵢ to the outer longitudinal section L_{ä} is defined by the plane E₀ perpendicular to the longitudinal axis 10, and the blade tip 12 is defined by the plane E_{E}. The location of the plane E₀ in the present example is at a relative length x/L of 0.9, but can also assume any intermediate value between 0.80 and 0.98.

The measures proposed according to the invention for reducing the acoustic emissions relate primarily to the outer longitudinal section L_{ä} of the rotor blade 6, and thus the region between the planes E₀ and E_{E}.

FIG. 3 represents a cross-section through the rotor blade 6 in the plane E₀, and thus shows the aerodynamic profile present in the plane E₀. This blade has a leading edge 13 and a trailing edge 14, whose mutual distance perpendicular to the longitudinal axis 10 determines the chord t. While the leading edge 13 is composed of the apex of the profile curve, which has a continuous curvature there, the trailing edge 14 terminates in a step with height h for manufacturing reasons. The straight line through the leading edge 13 and trailing edge 14 is designated the chord line 15. The midpoints between the suction side 9 and the pressure side 16 produce the median line 17.

The aerodynamic profile present in the cross-sectional plane E₀ is additionally characterized by a continuously curved suction side 9 and a likewise continuously curved pressure side 16, whose greatest mutual distance defines the thickness d of the profile. The relative thickness d/t is the ratio of the thickness d to the chord t in the applicable cross-sectional plane. The curvature f is defined by the maximum distance of the median line 17 from the chord line 15. The relative curvature f/t is indicated by the ratio of the curvature f to the chord t in the pertinent cross-sectional plane.

FIG. 4 shows the aerodynamic profile of the rotor blade 6 in the cross-sectional plane E_{E}. As compared to the profile shown in FIG. 3, the one shown in FIG. 4 has a chord t reduced by approximately 15%, a twist ⊖ greater by approximately 4°, a relative curvature f/t reduced to a value of zero, and a relative thickness d/t shaved down to a value of approximately 10%. These measures contribute to the fact that the aerodynamic profiles between the planes E₀ and E_{E} have a reduced cₐ value overall.

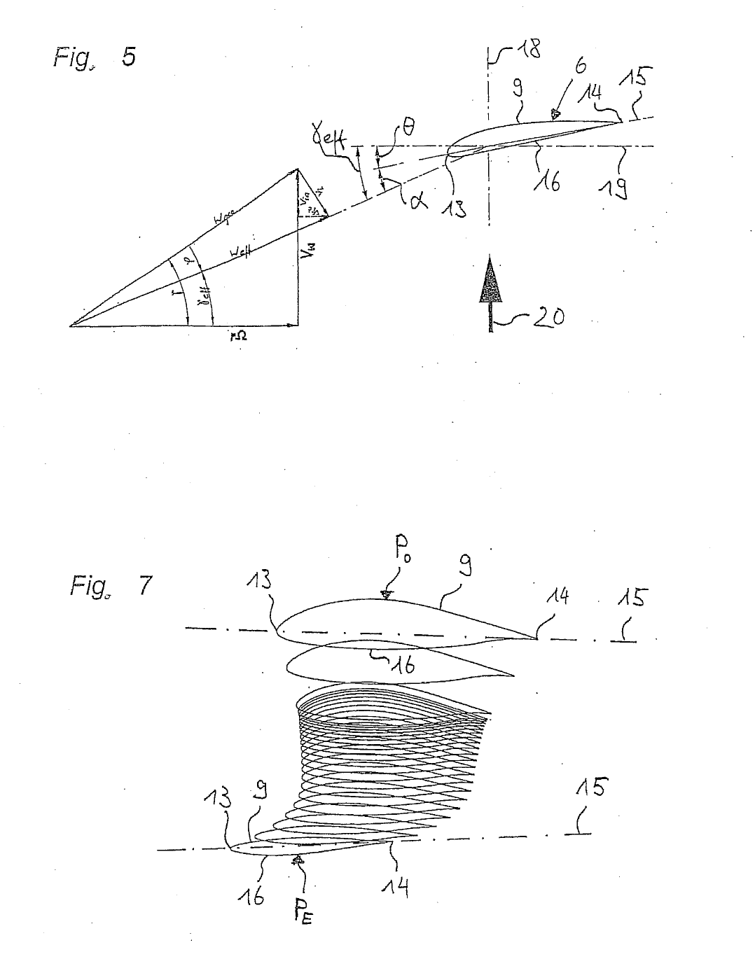

FIG. 5 illustrates the geometric and kinematic relationships at a rotor blade 6 of a wind turbine in operation. The rotor blade 6 describes a rotor plane 19 by rotation about the axis of rotation 18. The pressure side 16 of the rotor blade 6 faces the wind 20. To produce thrust, the blade 6 is inclined with its leading edge 13 toward upwind, while the trailing edge 14 faces downwind. The degree of inclination reflects the angle between the rotor plane 19 and the chord line 15 of the rotor blade 6. This angle describes the twist ⊖, which is composed of a local blade twist characteristic of the radial distance from the rotor axis 18, and a blade angle that is uniform over the entire blade length; the blade angle is variable in pitch-controlled wind turbines, and is fixed in stall-controlled wind turbines.

FIG. 5 also shows a wind triangle with a wind component v_{W} oriented approximately perpendicularly to the rotor plane 19. The component perpendicular thereto, hence parallel to the rotor plane 19, corresponds to the airflow arising due to the circumferential velocity Ω×r, which increases linearly toward the blade tip as a result of the increasing radius. Together, the magnitude and direction of the two components result in the geometric inflow w_{geo}. To account for the disturbance of the inflow by the rotor itself, a correction to the geometric inflow w_{geo} by the downwash angle φ to account for the downwash is required, resulting in the effective inflow w_{eff}. The angle between the effective inflow w_{eff} and the chord line 15 of the rotor blade 6 represents the effective angle of attack α. The twist ⊖ and the angle of attack α together form the effective pitch angle γ_{eff}.

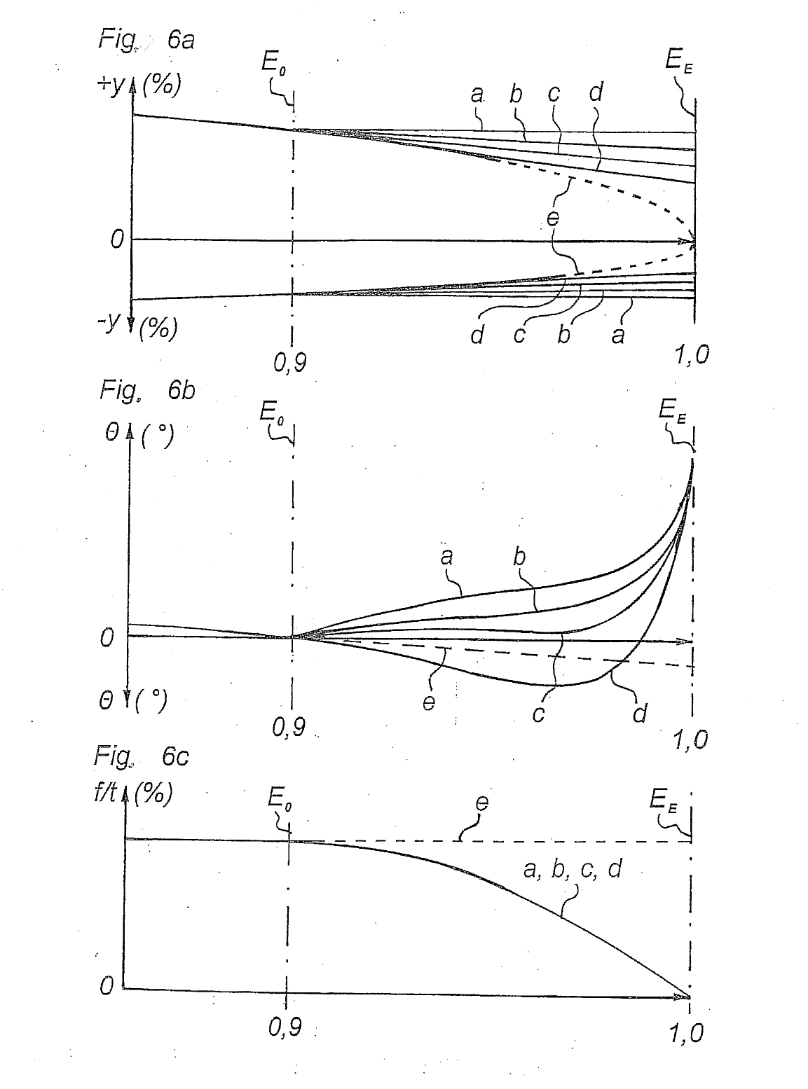

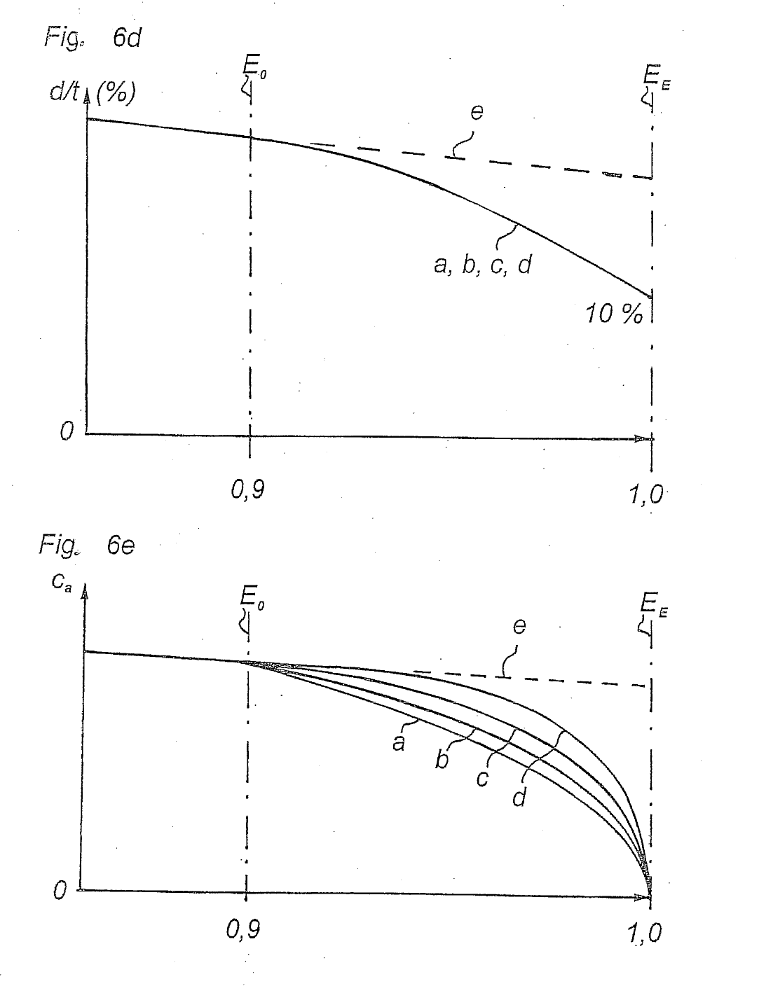

The curve of the aforementioned profile parameters from the plane E₀ to the plane E_{E} is represented in FIGS. 6a to 6e. In the graphs shown there, the ordinate represents the relative length x/L of the rotor blade 6 in the region of the outer longitudinal section L_{ä} and the directly adjoining section of the longitudinal section Lᵢ.

In FIG. 6a, the Y-coordinates of the leading edge 13 and trailing edge 14 are plotted on the abscissa; the curve of the chord t results from their difference. In this regard, FIG. 6a shows different embodiments of the invention with the blade chord curves a through d, while curve e represents a conventional rotor blade. A characteristic of the plot a is that the blade chord t in the outer longitudinal section L_{ä} constantly corresponds to the blade chord t in the cross-sectional plane E₀. In contrast, the curves b, c and d are characterized by a linear, gradually converging course of the leading edge 13 and trailing edge 14 between the planes E₀ and E_{E}, which is to say the chord t decreases towards the cross-sectional plane E_{E}, preferably linearly. The transition from the inner longitudinal section Lᵢ to the outer longitudinal section L_{ä} is continuous here. Starting from 100% blade chord t in the cross-sectional plane E₀, the blade chord t decreases in the curve b to a blade chord t of approximately 85% in the plane E_{E}, in the curve c to 72%, and in the curve d to 60%. Arbitrary intermediate values reside within the scope of the invention.

Evident in FIG. 6b is the plot of the twist ⊖ in the longitudinal section L_{ä} as a function of the above-described blade chord curves a through d, wherein associated curves are labeled with the same reference letters a through d. The twist curve a increases continuously from the cross-sectional plane E₀, first almost linearly or in a slightly regressive manner to a relative length of approximately 0.97, then with progressive slope to the cross-sectional plane E_{E}. The curve b has a similar but less pronounced shape. The twist curves c and d differ from this in that they have a moderate, negative slope between the cross-sectional planes E₀ and E_{E} in the direction towards the blade tip, and after reaching a minimum in the outer half of the outer longitudinal section L_{ä}, this slope transitions into a progressively increasing positive slope. Common to all the curves is a sharp increase in the twist ⊖ in the outer third of the outer longitudinal section L_{ä}, preferably to a value approximately 4° above the twist in the cross-sectional plane E₀. The transition of the twist ⊖ from the inner longitudinal section Lᵢ to the outer longitudinal section L_{ä} also preferably has a continuous course.

The curve shown in FIG. 6c reflects the inventive shape of the relative curvature f/t between the cross-sectional planes E₀ and E_{E}. The curve continuously adjoins the longitudinal section Lᵢ, and decreases continuously towards the cross-sectional plane E_{E} until the value 0% is reached at the blade tip 12.

The relative thickness d/t exhibits a shape similar to that shown in FIG. 6d over the longitudinal section L_{ä}, which likewise continuously extends the shape of the inner longitudinal section Lᵢ, and progressively or linearly decreases in the direction of the cross-sectional plane E_{E} to a value of approximately 10%.

FIG. 6e shows the plot of the lift coefficient cₐ, which is the result of the measures described in relation to FIGS. 6a to 6d. The curves a through d again correspond to the curves a through d of the blade chord t and twist ⊖. The curves proceed continuously from the shape in the longitudinal section Lᵢ, and drop disproportionately in the direction of the cross-sectional plane E_{E}, which is to say progressively, to reach the value of zero at the blade tip 12. The different curves demonstrate in this connection that the greater the chord t of the rotor blade 6 and the greater twist ⊖ correlated therewith, the sharper the reduction in cₐ value that can be achieved, which ultimately leads to the desired noise reduction.

The curve of the twist ⊖ plotted in FIG. 6b is illustrated pictorially in FIG. 7. FIG. 7 shows a plurality of profile cross-sections in the region of the outer longitudinal section L_{ä} from a direction of view facing radially towards the axis of rotation 18, wherein the profile lying in the cross-sectional plane E₀ is labeled P₀, and the one in the cross-sectional plane E_{E} is labeled P_{E}. The associated chord line 15 is shown for these two profile cross-sections. Their converging path shows that the twist ⊖ of the cross-sectional profile P_{E} in the cross-sectional plane E_{E} is greater than the twist ⊖ of the profile cross-section P₀ in the cross-sectional plane E₀, and specifically by about 4° in the present case. Moreover, one can see the decrease in the relative curvature f/t from the profile P₀ with a predetermined curvature to the fully symmetrical profile P_{E} with the curvature of zero in the cross-sectional plane E_{E}. The relatively slim profile P₀ at the blade tip as compared to the profile P_{E} is the result of shaving down the thickness to approximately 10%. The additional pre-curve Δz toward upwind becomes evident in that the profile sections are displaced toward the pressure side 16 in the direction of the cross-sectional plane E_{E}. In corresponding fashion, the forward sweep is made visible, which results from the offset of the last six profile cross-sections before the cross-sectional plane E_{E} in the direction of its leading edge 13.

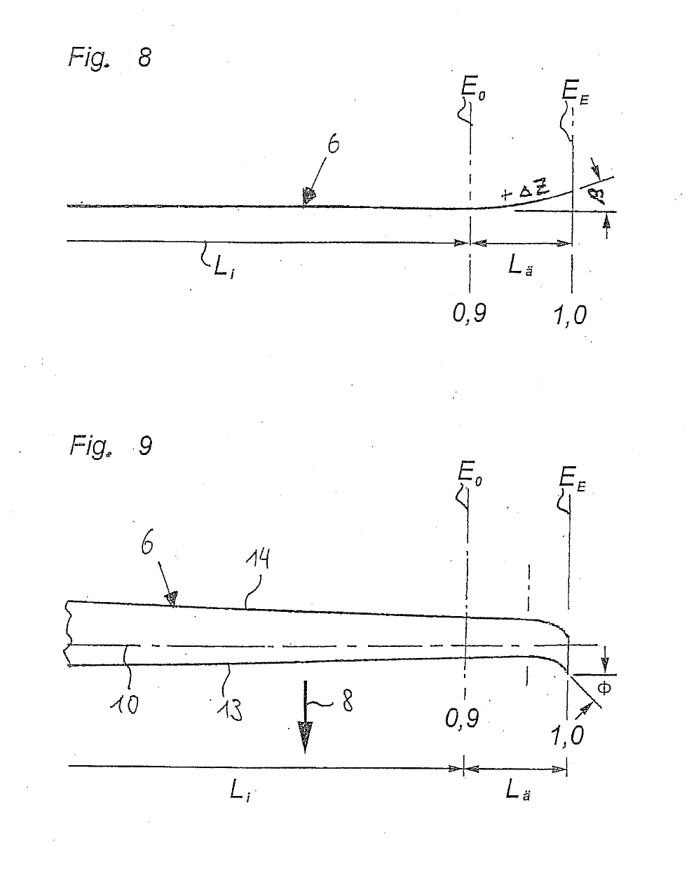

FIG. 8 relates to an embodiment of the invention in which the rotor blade 6 has a conventional pre-curve toward upwind, on which is superimposed, in the outer longitudinal section L_{ä}, an additional pre-curve Δz toward upwind. In this way, a pre-curve angle β results at the blade tip, which according to the invention can assume a value of up to 30°, preferably 20°.

As FIG. 9 shows, the blade end region can be provided with sweep in the direction of rotation 8 (forward sweep), either as an alternative to or together with the additional pre-curve. To this end, the outer longitudinal section L_{ä} of the rotor blade 6 is bent forward in the direction of rotation, wherein a forward sweep angle φ occurs between the blade tip and the longitudinal axis 10 or pitch axis of the rotor blade 6 that according to the invention is ≦60°, preferably lies between 30° and 60°, most preferably is 45°. The forward sweep of the rotor blade 6 can start as soon as in the plane E₀, or not until later, as shown in FIG. 9. Both the additional pre-curve and the forward sweep in the longitudinal section L_{ä} are very clearly evident in FIG. 7, as well.

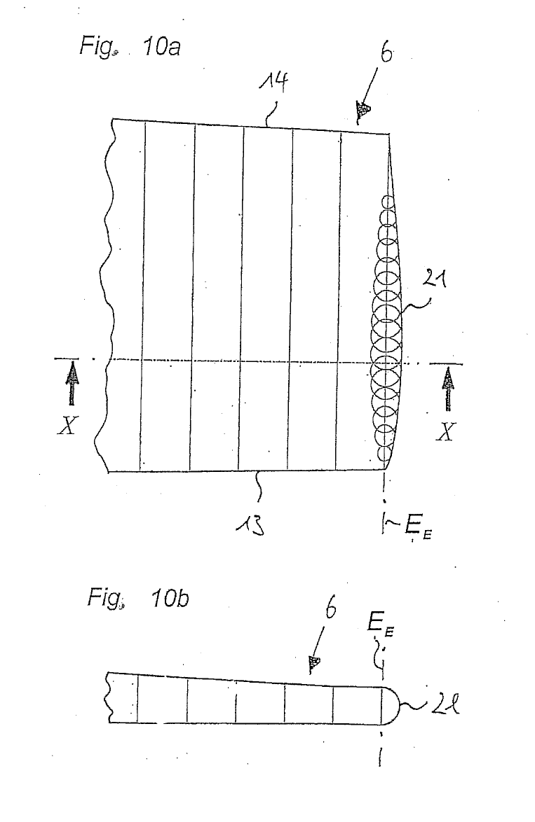

In the embodiment of an inventive rotor blade 6 shown in FIGS. 10a and b, a wing tip edge 21 adjoins the cross-sectional plane E_{E}. In the region of the cross-sectional plane E_{E}, the wing tip edge 21 originates from a fully symmetrical cross-sectional profile, which is to say the relative curvature f/t of the profile is zero. Thus, the wing tip edge 21 can be made in a simple manner by rotating through 180° the profile-forming contour line of the suction side 9 or pressure side 16. The wing tip edge 21 thus represents half of a body of rotation.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A rotor blade for a wind turbine, the rotor blade comprising:
an absolute length L extending from the blade attachment to the blade tip; and
a relative blade length x/L proceeding from the blade attachment,
wherein the rotor blade is divided into an inner longitudinal section Li associated with the blade attachment and an outer longitudinal section Lä associated with the blade tip,
wherein the transition from the inner longitudinal section Li to the outer longitudinal section Lä defines a cross-sectional plane E0,
wherein the blade tip defines a cross-sectional plane EE,
wherein the rotor blade has a specific aerodynamic profile as a function of the relative blade length x/L with a chord t, a twist ⊖, a relative thickness d/t, a relative curvature f/t, and a relative trailing edge thickness h/t, and
wherein the cross-sectional plane E0 is located at a relative blade length x/L in the range between 0.80 and 0.98, the blade chord t of the aerodynamic profile in the cross-sectional plane EE is at least 60% of the blade chord t of the aerodynamic profile in the cross-sectional plane E0, and the blade twist ⊖ of the aerodynamic profile in the cross-sectional plane EE is greater than the blade twist ⊖ of the aerodynamic profile in the cross-sectional plane E0.

2. The rotor blade according to claim 1, wherein the blade twist ⊖ of the aerodynamic profile in the cross-sectional plane EE is 3° to 5° greater, preferably 4° greater, than the blade twist ⊖ of the aerodynamic profile in the cross-sectional plane E0.

3. The rotor blade according to claim 1, wherein the cross-sectional plane E0 is located at a relative blade length x/L in the range between 0.88 and 0.92, preferably at 0.9.

4. The rotor blade according to claim 1, wherein the blade chord t in the cross-sectional plane EE is less than or equal to 1.2 times the blade chord t in the cross-sectional plane E0 or less than or equal to the blade chord t in the cross-sectional plane E0 or between 0.7 times and 0.8 times the blade chord t in the cross-sectional plane E0.

5. The rotor blade according to claim 1, wherein a curve of the blade chord t is continuous from the cross-sectional plane E0 to the cross-sectional plane EE.

6. The rotor blade according to claim 1, wherein a curve of the blade twist ⊖ increases continuously in a direction of the cross-sectional plane EE, starting from the cross-sectional plane E0.

7. The rotor blade according to claim 1, wherein a curve of the blade twist ⊖ in a direction of the cross-sectional plane EE, starting from the cross-sectional plane E0, and first assumes a minimum and then increases continuously from the minimum in the direction of the cross-sectional plane E0.

8. The rotor blade according to claim 6, wherein the curve of the blade twist ⊖ increases progressively toward the cross-sectional plane EE in the continuously progressing region.

9. The rotor blade according to claim 1, wherein the relative curvature f/t of the aerodynamic profile is smaller in the cross-sectional plane EE than the relative curvature f/t of the aerodynamic profile in the cross-sectional plane E0, preferably being zero in the cross-sectional plane EE.

10. The rotor blade according to claim 9, wherein the shape of the relative curvature f/t is continuous from the cross-sectional plane E0 to the cross-sectional plane EE, preferably progressively decreasing.

11. The rotor blade according to claim 1, wherein the relative thickness d/t of the aerodynamic profile is smaller in the cross-sectional plane EE than the relative thickness d/t of the aerodynamic profile in the cross-sectional plane E0.

12. The rotor blade according to claim 11, wherein the shape of the relative thickness d/t is continuous from the cross-sectional plane E0 to the cross-sectional plane EE, preferably progressively decreasing.

13. The rotor blade according to claim 11, wherein the relative thickness d/t of the aerodynamic profile in the cross-sectional plane EE is 9% to 12%.

14. The rotor blade according to claim 1, wherein the shape of the chord t and/or the shape of the twist ⊖ and/or the shape of the relative curvature f/t and/or the shape of the relative thickness d/t continuously adjoins that of the longitudinal section Li of the rotor blade in the cross-sectional plane E0.

15. The rotor blade according to claim 1, wherein a wing tip edge is arranged subsequent to the cross-sectional plane EE.

16. The rotor blade according to claim 15, wherein the rotor blade has no curvature in the cross-sectional plane EE, and the shape of the wing tip edge is formed by rotation of the contour of the pressure side or suction side about the chord line.

17. The rotor blade according to claim 1, wherein the relative height h/t of the trailing edge of the rotor blade, at least in the region E0 to EE, is less than or equal to 2 ‰, starting from a relative length x/L that is greater than 0.5.

18. The rotor blade according to claim 1, further comprising an additional pre-curve Δz toward upwind in the outer longitudinal section Lä of the rotor blade.

19. The rotor blade according to claim 18, wherein the additional pre-curve Δz proceeds continuously and progressively from E0 to EE, and adjoins the inner longitudinal section Li of the rotor blade in a continuous manner, wherein the angle of pre-curve β in the cross-sectional plane EE is 10° to 30°, preferably 20°.

20. The rotor blade according to claim 1 through 19, further comprising a forward sweep in the outer longitudinal section Lä of the rotor blade in the direction of rotation.

21. The rotor blade according to claim 20, wherein the forward sweep proceeds continuously and progressively from E0 to EE, and adjoins the inner longitudinal section Li of the rotor blade in a continuous manner, wherein the forward sweep angle φ in the cross-sectional plane EE is less than 60°, preferably 45°.

22. A wind turbine comprising a rotor blade according to claim 1.
